(19) United States
(12) Patent Application Publication
(10) Pub. No.: US 2004/0136717 A1
(43) Pub. Date: Jul. 15, 2004

(54) Non-blocking tunable filter with flexible bandwidth for reconfigurable optical networks

(76) Inventors: Xinxiong Zhang, Arcadia, CA (US); Vincent E. Stenger, West Covina, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/655,499

(22) Filed: Sep. 3, 2003

Related U.S. Application Data
(60) Provisional application No. 60/407,280, filed on Sep. 3, 2002.
(60) Provisional application No. 60/407,281, filed on Sep. 3, 2002.
(60) Provisional application No. 60/407,282, filed on Sep. 3, 2002.
(60) Provisional application No. 60/407,283, filed on Sep. 3, 2002.

(51) Int. Cl. H04J 14/02

(52) U.S. Cl. 398/85

(57) ABSTRACT

A reconfigurable non-blocking Optical Add/Drop Module (OADM). The OADM is tunable to drop one or more target channels from an optical signal without interfering with any channels between a starting channel and the dropped channels. During tuning, all of the channels in the optical signal are expressed. In one embodiment of the OADM, two tunable optical filters are optically coupled in a cascade series such that one or more channels may be dropped by tuning both to the dropped channels. The optical filters are electronically coupled to a common controller that controls the operation of each of the tunable filters. The filters are tuned separately to reach the target dropped channels without interfering with any intermediate channels.

### CROSS-REFERENCE TO RELATED APPLICATIONS

This application claims the benefit of U.S. Provisional Patent Application No. 60/407,281, filed Sep. 3, 2002, U.S. Provisional Patent Application No. 60/407,280, filed Sep. 3, 2002, and U.S. Provisional Patent Application No. 60/407,283, filed Sep. 3, 2002, and U.S. Provisional Patent Application No. 60/407,282, filed Sep. 3, 2002, the contents of which are hereby incorporated by reference as if fully stated herein.

### BACKGROUND OF THE INVENTION

As data traffic such as for internet and digital cable TV services has increased in recent years, more demands have been placed on existing communications networks to make the maximum possible use of available bandwidth. Toward this end, it is advantageous to dynamically maintain the shortest possible route for any data traffic. This usually requires switching of the individual data signals from one network to another. It is thus desirable to be able to rapidly switch and re-route various data signals to maintain optimal paths and assure that bandwidth allocations for customers are met. This is especially true at the metropolitan (access) level, where there are many more access points as compared to long haul (city to city) data traffic. Metro access traffic in particular has been identified as the dominant bandwidth bottleneck in existing telecommunications networks.

In optical networks, data signals are present on optical fibers as modulations of light intensities over discrete optical frequency bands or channels centered at specific light wavelengths. The conventional approach to switching and routing of these optical data signals has been to strip away the optical bands using optical demultiplexers, and then to convert them to electrical signals (o-e conversion). The electrical signals are readily switched to other routes, where they are converted back to optical signals (e-o conversion) and inserted back onto a different path of the optical network using an optical multiplexer. The component used for optical multiplexing and demultiplexing functions is the optical add/drop module (OADM). The o-e and e-o conversions stem from the fact that existing OADM devices are fixed in optical wavelength and optical bandwidth. A more efficient and higher speed routing can be achieved if the routing could all be done at the optical level, eliminating the need for o-e and e-o conversions. This is based on the inherent noise and bandwidth limitations of the o-e and e-o devices. The key to implementing the all-optical routing is the reconfigurable OADM. This device offers dynamic (tunable) channel optical wavelength and bandwidth selection. With the continued growth in the industry, a premium has been placed on the scalability and interconnectivity of any hardware solution over various network platforms. The realization of such a reconfigurable OADM has thus become especially relevant in the current environment.

An improved OADM should feature adjustable optical channel selection. In addition, such a device should not interfere with intermediate channels as the device is tuned from one channel to another, thus achieving true non-blocking operation at all times. In addition, it would be advantageous to have an OADM that included an adjustable optical bandwidth so that one or more optical channels may be dropped and rerouted within a single device. Such an adjustable or “flexible” bandwidth device enables dynamic scalability of the network. As bandwidth needs at a node change, the device can upgrade or downgrade accordingly for more efficient use of network resources.

### SUMMARY OF THE INVENTION

A tunable reconfigurable non-blocking Optical Add/Drop Module (OADM) is provided. The OADM is tunable to drop one or more target channels from an optical signal without interfering with any channels between a starting channel and the dropped channels. During tuning, all of the channels in the optical signal are expressed. In one embodiment of the OADM, two tunable optical filters are optically coupled in a cascade series such that one or more channels may be dropped by tuning both to the dropped channels. The optical filters are electronically coupled to a common controller that controls the operation of each of the tunable filters. The filters are tuned separately to reach the target dropped channels without interfering with any intermediate channels.

In one aspect of the invention, a reconfigurable non-blocking Optical Add/Drop Module (OADM) includes a first tunable optical filter having an input port, a dropped channel port, an express port, and an add port. The second OADM further includes a second tunable optical filter having an input port optically coupled to the first filter's dropped channel port, an express port optically coupled to the first filter's add port, and a dropped channel port. A controller is electronically coupled to the first optical filter and the second optical filter.

In another aspect of the invention, the first optical filter generates an intermediate dropped optical signal including an intermediate dropped channel in response to an input optical signal and a first channel select signal received from the controller. The intermediate dropped optical signal is then transmitted from the first optical filter's dropped port to the input port of the second optical filter.

In another aspect of the invention the, second optical filter generates an intermediate expressed optical signal including an intermediate expressed channel in response to the intermediate dropped optical signal and a second channel select signal received from the controller. The intermediate expressed optical signal is then transmitted from the second optical filter's express port to the add port of the first optical filter.

In another aspect of the invention, the first channel select signal and the second channel select signal select the same channel in order to drop the channel. To express all the channel, the first channel select signal and second channel select signal select different channels.

In another aspect of the invention, a reconfigurable non-blocking OADM includes a first tunable optical filter having an input port, a dropped channel port, an express port, and an add port. A second tunable optical filter included in the OADM has an input port optically coupled to the first filter's dropped channel port, an express port optically coupled to the first filter's add port, and a dropped channel port. A controller is electronically coupled to the first optical filter and the second optical filter. The controller further includes a processor and a memory coupled to the processor. The memory includes program instructions executable by the processor for operation of the first optical filter and the second optical filter.

In another aspect of the invention, the program instructions further include: tuning the first optical filter from a start channel to a target channel; and tuning the second optical filter from a start channel to the target channel.

In another aspect of the invention, the program instructions further include: tuning the first optical filter from a start channel to a first channel adjacent to the start channel; tuning the second filter from the start channel to a second channel adjacent to the start channel; tuning the first optical filter from the first channel to a third channel adjacent to a target channel; tuning the second optical filter from the second channel to a fourth channel adjacent to the target channel; tuning the first optical filter from the third channel to the target channel; and tuning the second optical filter from the fourth channel to the target channel.

In another aspect of the invention, the first filter may drop a first set of channels and the second filter may drop a second set of channels. In one tuning configuration, the first optical filter generates an intermediate dropped optical signal including a set of intermediate dropped channels in response to an input optical signal and a first channel select signal received from the controller. The intermediate dropped optical signal is then transmitted from the first optical filter's dropped port to the input port of the second optical filter.

In another aspect of the invention, the second optical filter generates an intermediate expressed optical signal including a set of intermediate expressed channels in response to the intermediate dropped optical signal and a second channel select signal received from the controller. The intermediate expressed optical signal is then transmitted from the second optical filter's express port to the add port of the first optical filter.

In another aspect of the invention, the first channel select signal selects a first set of dropped channels and the second channel select signal selects a second set of dropped channels having a non-empty intersection with the first set of dropped channels.

In another aspect of the invention, the first channel select signal selects a first set of dropped channels and the second channel select signal selects a second set of dropped channels having an empty intersection with the first set of dropped channels.

### BRIEF DESCRIPTION OF THE DRAWINGS

These and other features, aspects, and advantages of the present invention will become better understood with regard to the following description, appended claims, and accompanying drawings where:

FIG. 1a to FIG. 1c are graphical representations of the operation of a non-blocking tunable filter in accordance with an exemplary embodiment of the present invention;

FIG. 2 is a block diagram of the operation of a wavelength tunable filter in accordance with an exemplary embodiment of the present invention;

FIG. 3 is a block diagram of a non-blocking tunable filter in accordance with an exemplary embodiment of the present invention;

FIG. 4a to FIG. 4b are a sequence of graphs illustrating the operation of a non-blocking tunable filter in accordance with an exemplary embodiment of the present invention;

FIG. 5 is a sequence diagram of the operations of a non-blocking tunable filter in accordance with an exemplary embodiment of the present invention; and

FIG. 6a to FIG. 6c are graphical representations of the operation of a flexible bandwidth non-blocking tunable filter in accordance with an exemplary embodiment of the present invention.

### DETAILED DESCRIPTION

To achieve non-blocking or “hitless” operation in a tunable WDM filter module, reflection bands or express channels should be unaffected as the band-pass transmission spectrum of the filter is tuned from one wavelength to another. That is, transmission only occurs at the wavelengths desired. This is needed for so-called “reconfigurable network” OADM elements, whereby intermediate reflected or “express” channels should not be dropped as the tunable OADM is changed from one optical channel to another.

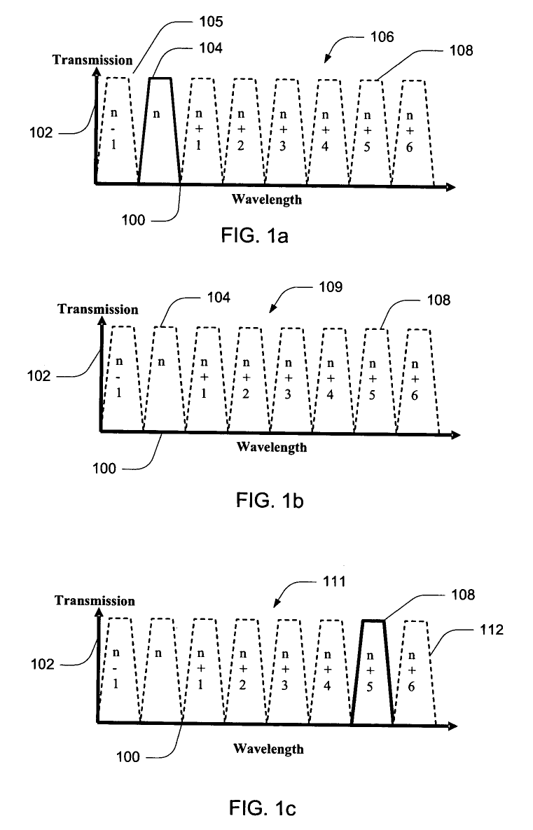

FIG. 1a to FIG. 1c are graphical representations of the operation of a non-blocking tunable filter in accordance with an exemplary embodiment of the present invention. In the graphs, the possible outputs of a non-blocking tunable optical filter are illustrated along a graph of transmission versus wavelength for specific channels having defined wavelength bands. The channels processed by the filter are illustrated on a graph having each channel plotted along an X axis 100 and relative transmission of the wavelengths in the channel along a Y axis 102. A transmitted (dropped) channel is illustrated as a channel with a solid outline. A reflected (expressed) channel is illustrated by a dashed outline.

Referring now to FIG. 1a, channel n 104 is shown as being a currently dropped channel with a solid outline. Channel n−1 105 and channels n+1 to N+6 106 are shown as being expressed with a dashed outline. During a tuning process, the non-blocking tunable filter is tuned from the current channel 104 to a target channel, n+5 108, without blocking the intermediate channels.

FIG. 1b is a graph of the state of a non-blocking tunable filter during a transitional or tuning phase. As illustrated, channels n−1 to n+6 109 are shown as being expressed using a dashed outline. During the transitional phase, all channels are expressed as the non-blocking tunable filter tunes from a current channel 104 to the target channel.108.

FIG. 1c is a graph of the state of a non-blocking tunable filter after it has tuned to a target dropped channel. In the graph, channels n−1 to n+4 111 and channel n+6 112 are shown with dashed outlines indicating that they are expressed by the non-blocking tunable filter. Channel n+5 108 is shown with a solid outline indicating that it is being dropped or transmitted by the non-blocking tunable filter.

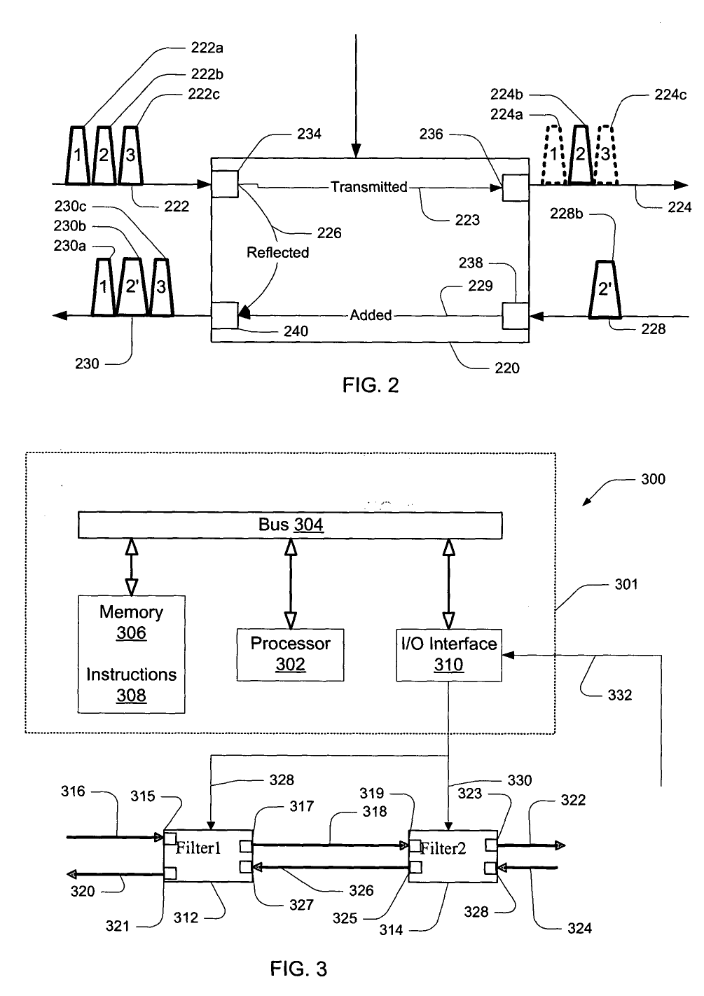

FIG. 2 is a block diagram of the operation of a tunable Optical Add/Drop Module (OADM) in accordance with an exemplary embodiment of the present invention. An OADM 220 receives an input optical signal 222 at an input port 234. The input optical signal may have multiple channels with each channel occupying specific optical bandwidths at various channel wavelengths, such as channel 1 222a, channel 2 222b, and channel 3 222c. In the optical signals, some of the channels may be present and are indicated using a solid outline. Some of the channels may be absent and these are indicated by a dashed outline.

Within the tunable filter, a dropped channel is transmitted (223) through the device and out of a drop port 236 as a component of a dropped optical signal 224. As illustrated, the dropped optical signal includes dropped channel 2 224b as indicated by channel 2's solid outline. Channels 1 224a and 3 224c are not present in the dropped optical signal as indicted by their dashed outlines.

The input channels that are not transmitted as part of the dropped optical signal are reflected (226) by the device as components of an expressed optical signal 230 out of an express port 240. Channels may also be added (229) to the expressed optical signal by the filter. For example, an add optical signal 228 at an add port 238 may contain an optical signal on channel 2′ 228b corresponding to the dropped channel 2 224b. The resultant expressed optical signal 230 then includes channel 1 230a, channel 2′ 230b, and channel 3 230c. An input optical signal on channel 2 222b is dropped as channel 2 224b. The dropped channel was replaced in the expressed optical signal by channel 2′ 230b.

Several manufacturers provide thin film filter or grating based tunable wavelength OADMs with 3 and 4 port versions available. One such company is Micron Optics, Inc. of Atlanta, Ga. U.S.A. whose CTF-TF series offers flat top spectral response and whose CTF-C series offers external controller inputs.

FIG. 3 is a block diagram of a non-blocking tunable filter in accordance with an exemplary embodiment of the present invention. Non-blocking operation with tunable filters may be achieved using two tunable filters in a cascaded series whose operations are coordinated by a common controller. A non-blocking tunable filter 300 includes a controller 301 electronically coupled to a first filter 312 and a second filter 314. The first and second filters are optically coupled in a cascaded series. The controller includes a processor 302 coupled via a bus 304 to a memory 306. The memory includes programming instructions 308 executable by the processor to control the operations of the two coupled filters. The controller further includes an Input/Output (I/O) interface 310 for receiving external input signals and transmitting control signals to the two filters.

The first filter 312 has an input port 315 for receiving an input optical signal 316. The input optical signal may include channels to drop and channels to express. The first filter's dropped port 317 is optically coupled to the second filter's input port 319 such that an intermediate dropped optical signal 318 including an intermediate dropped channel is transmitted to the second filter's input port 319.

The first filter's add port 327 is optically coupled to the second filter's express port 325 such that an intermediate expressed optical signal 326 transmitted by the second filter is received by the first filter as an add optical signal. The intermediate expressed optical signal includes channels expressed by the second filter.

The second filter further includes a dropped port 323 for output of a dropped optical signal including one or more dropped channels that are dropped by both the first filter and the second filter. The second filter further includes an add port 328 for input of an add optical signal 324 that may include an add channel that will be added to the channels expressed by the second filter.

The first filter further includes an express port 320 for output of an expressed optical signal 320. The expressed optical signal may include channels expressed by the first and second filter and channels added by the second filter.

Each of the filters is electronically coupled to the controller. The first filter receives a first wavelength select signal 328 from the controller. The second filter receives a second wavelength select signal 330 from the controller. The controller receives a master channel select signal 332 from an external source. The controller commands the first and second filters using the first and second select signals to tune both filters to one or more channels indicated by the master channel select signal as will be discussed below.

If the first and second filter are commanded to drop the same channels, an input optical signal is processed in the following manner. The first filter receives the input optical signal having one or more channels selected to be dropped. The first filter transmits the selected drop channels to the second filter. The second filter receives the selected drop channels and transmits the selected drop channels through to the second channel's dropped port as components of a dropped optical signal having the selected dropped channels. As the intermediate dropped optical signal includes only the selected dropped channels, the second filter does not express any channels other than added channels. The first filter expresses all of the channels not selected as drop channels and all of the channels added by the second filter.

If the first and second filter are commanded to drop different channels, an optical signal received by the first optical filter is processed in the following manner. The first filter receives the optical signal and transmits an intermediate dropped channel optical signal including any dropped channels to the second filter. However, as the second filter is commanded to drop different channels, the second filter reflects the channels dropped by the first filter back to the first filter as an intermediate expressed optical signal including the channels originally dropped by the first filter. No channels reach the second filter's dropped port. Any added channels received by the second filter are also transmitted to the first filter as part of the intermediate expressed optical signal. The first filter receives the intermediate expressed optical signal, including the intermediate dropped channels transmitted by the first filter to the second filter, as an add signal. The first filter's expressed optical signal then includes all of the channels reflected by the first filter, and any channels originally dropped by the first filter but expressed by the second filter. All of the channels added by the second filter are blocked from the first filter express path, as the first and second filter are set to different channels.

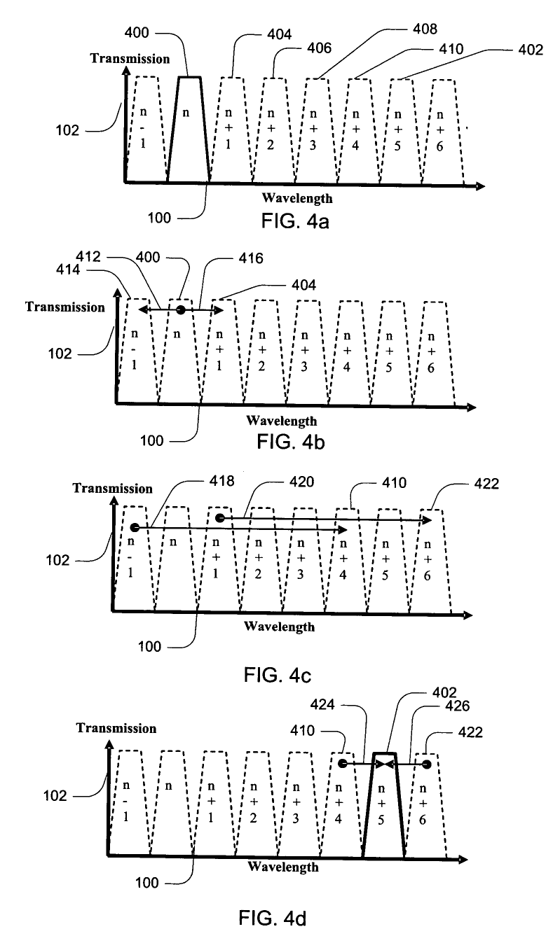

FIG. 4a to FIG. 4b are a sequence of graphs illustrating the operation of a non-blocking tunable filter in accordance with an exemplary embodiment of the present invention. In the graphs, the possible outputs of a non-blocking tunable optical filter are illustrated along a graph of transmission versus wavelength for specific channels having defined wavelength bands. The channels processed by the filter are illustrated on a graph having each channel plotted along an X axis 100 and relative transmission of the wavelengths in the channel along a Y axis 102. A transmitted or dropped channel is illustrated as a channel with a solid outline. A reflected or expressed channel is illustrated by a dashed outline.

Referring now to FIG. 4a, initially, the first filter 312 and the second filter 314 (both of FIG. 3) are tuned to a starting channel, channel n 400, thus allowing transmission of the starting channel. To tune to a target channel, in this example channel n+5 402, each filter needs to pass through expressed channels n+1 404, n+2 406, n+3 408, and n+4 410.

Referring now to FIG. 4b, the first filter 312 (of FIG. 3) is detuned (412) from the starting channel n 400 to a channel adjacent to the starting channel, channel n−1 414. The second filter 314 (of FIG. 3) is detuned (416) to another channel adjacent to the starting channel but in an opposite direction as the first filter from the current channel, in this case channel n+1 404. As noted above, as the first and second filters are tuned to different channels, all of the channels are reflected as express channels as indicated by the dashed outlines of the illustrated channels.

Referring now to FIG. 4c, the second filter 314 (of FIG. 3) is tuned to a channel adjacent to the target channel, in this example to channel n+6 422. The first filter 312 (of FIG. 3) is tuned (418) to another channel adjacent to the target channel but in an opposite direction as the second filter, in this example to channel n+4 410.

Referring now to FIG. 4d, the first filter is tuned (424) to the target channel 402 from the first filter's adjacent channel 410. The second filter is tuned (426) from the second filter's adjacent channel 422 to the target channel 402. As both filters are now tuned to the target channel, the target channel is dropped by both filters as indicated by the target channel's solid outline.

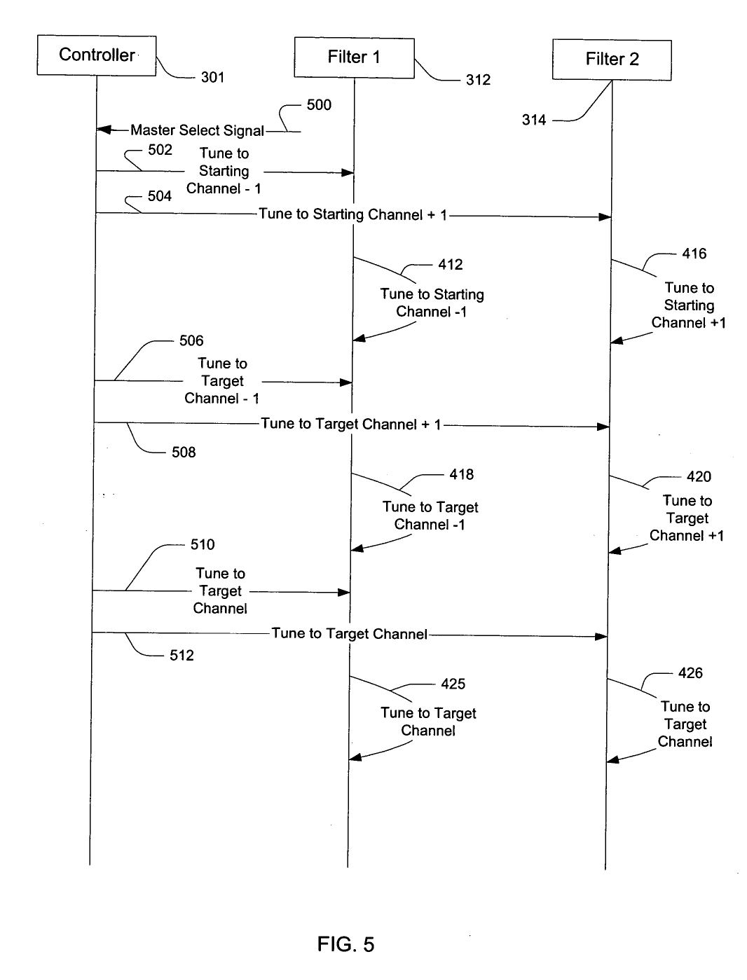

FIG. 5 is a sequence diagram of the operations of a non-blocking tunable filter in accordance with an exemplary embodiment of the present invention. The controller 301 receives a master channel select signal 500 indicating which channels should be dropped. In response to the master channel select signal, the controller transmits a channel select signal 502 to the first filter 312 to tune to a channel adjacent to a starting channel. The controller simultaneously transmits a command signal 504 to the second filter 314 instructing the second filter to tune to a channel adjacent to the starting channel but different than the channel tuned to by the first filter. In response to the command signals, the first filter and the second filter simultaneously tune 412 and 416 to their separate channels adjacent to the starting channel.

The controller then issues a command signal 508 to the second channel to tune to a channel adjacent to the target channel. In response to the command signal, the second filter tunes (420) itself to the appropriate channel. The controller simultaneously issues a command signal 506 to the first filter to tune to another channel adjacent to the target channel but different than the channel tuned to by the second filter. In response, the first filter tunes to specified channel adjacent to the target channel. The filter tuning is such that neither filter crosses the same channel at the same time.

The controller issues a command signal 510 to the first channel and a command signal 512 to the second filter instructing the filters to tune to the target channel. In response, the first filter and the second filter tune (425 and 426 respectively) to the target channel simultaneously, thus completing the tuning process.

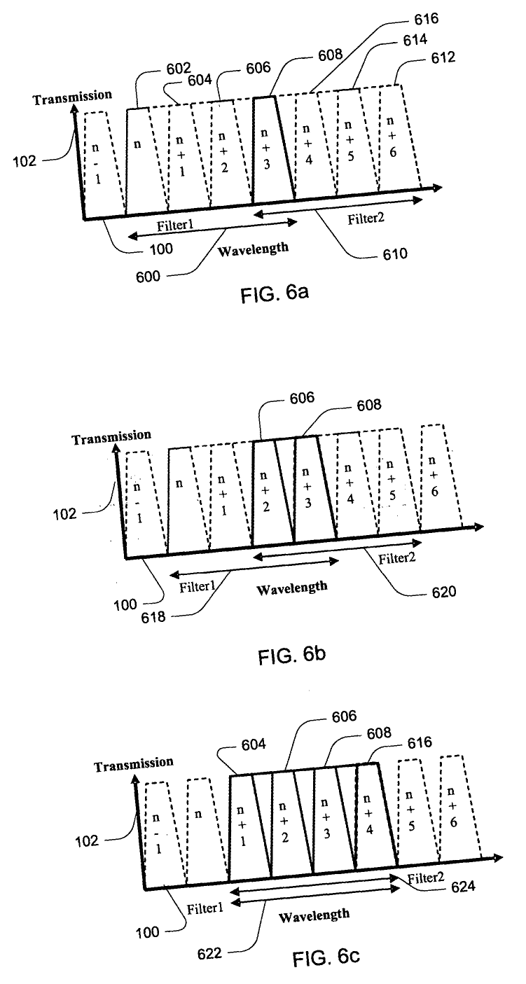

FIG. 6a to FIG. 6c are graphical representations of the operation of a flexible bandwidth non-blocking tunable filter in accordance with an exemplary embodiment of the present invention. Tunable filters may include thin film filter elements that may be used to drop blocks of adjacent channels from a WDM optical signal. Two such filters, optically coupled in a series cascade as previously described, may be advantageously employed to provide flexible control to drop one or more channels simultaneously. In the graphs, the possible outputs of a non-blocking tuned optical filter are illustrated along a graph of transmission versus wavelength for specific channels having defined wavelength bands. The channels processed by the filter are illustrated on a graph having each channel plotted along an X axis 100 and relative transmission of the wavelengths in the channel along a Y axis 102. A transmitted or dropped channel is illustrated as a channel with a solid outline. A reflected or expressed channel is illustrated by a dashed outline.

Referring now to FIG. 6a, a first filter 312 (of FIG. 3) is tuned to drop a first set 600 of channels, namely channel n 602, channel n+1 604, channel n+2 606, and channel n+3 608. A second filter 314 (of FIG. 3) is tuned to drop a second set 610 of channels, namely channel n+6 612, channel n+5 614, channel n+4 616, and channel n+3 608. As the first and second filter have one common dropped channel, channel n+3, the common dropped channel is included in a dropped optical signal generated by the second filter as indicated by channel n+3's solid outline. All of the rest of the channels, including those channels dropped by either the first filter or the second filter but not by both filters, are expressed as indicated by the channels dashed outlines.

Referring now to FIG. 6b, the first filter 312 (of FIG. 3) is tuned to drop a first set of channels 618. The second filter 314 (of FIG. 3 ) is tuned to drop a second set of channels 620. In this configuration, the overlap or intersection between the first and second set of dropped channels includes channel n+2 606 and channel n+3 608. As such, both channels are dropped by both filters and included in a dropped channel optical signal transmitted from the second filter as indicated by the included channel's solid outlines. All the rest of the channels are expressed as indicated by their dashed outlines. In the case where there is no overlap between the first and second set of dropped channels, that is the intersection between the two sets is empty, all of the channels will be expressed.

Referring now to FIG. 6c, a first set of dropped channels 622 dropped by the first filter 312 (of FIG. 3) is identical to a second set of channels 624 dropped by the second filter 314 (of FIG. 3). As such, channel n+1 604, channel n+2 606, channel n+3 608, and channel n+4 616 are included in a dropped channel optical signal transmitted from the second filter as indicated by the included channel's solid outlines. All the rest of the channels are expressed as indicated by their dashed outlines.

In all FIG. 6 cases above, add channels may be included in the transmission bands.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supported by this application and the claims' equivalents rather than the foregoing description.

What is claimed is:

1. A tunable reconfigurable non-blocking Optical Add/Drop Module (OADM) comprising:
a first tunable optical filter having an input port, a dropped channel port, an express port, and an add port;
a second tunable optical filter having an input port optically coupled to the first filter's dropped channel port, an express port optically coupled to the first filter's add port, and a dropped channel port;
a controller electronically coupled to the first optical filter and the second optical filter.

2. The reconfigurable OADM of claim 1, wherein the first optical filter generates an intermediate dropped optical signal including an intermediate dropped channel in response to an input optical signal and a first channel select signal received from the controller, the intermediate dropped optical signal transmitted from the first optical filter's dropped port to the input port of the second optical filter.

3. The reconfigurable OADM of claim 2, wherein the second optical filter generates an intermediate expressed optical signal including an intermediate expressed channel in response to the intermediate dropped optical signal and a second channel select signal received from the controller, the intermediate expressed optical signal transmitted from the second optical filter's express port to the add port of the first optical filter.

4. The reconfigurable OADM of claim 3, wherein the first channel select signal and the second channel select signal select the same channel.

5. The reconfigurable OADM of claim 3 wherein the first channel select signal and second channel select signal select different channels.

6. A reconfigurable non-blocking Optical Add/Drop Module (OADM) comprising:
a first tunable optical filter having an input port, a dropped channel port, an express port, and an add port;
a second tunable optical filter having an input port optically coupled to the first filter's dropped channel port, an express port optically coupled to the first filter's add port, and a dropped channel port;
a controller electronically coupled to the first optical filter and the second optical filter, the controller further including a processor and a memory coupled to the processor, the memory including program instructions executable by the processor for operation of the first optical filter and the second optical filter.

7. The reconfigurable OADM of claim 6, the program instructions further including:
tuning the first optical filter from a start channel to a target channel; and
tuning the second optical filter from a start channel to the target channel.

8. The reconfigurable OADM of claim 6, the program instructions further including:
tuning the first optical filter from a start channel to a first channel adjacent to the start channel;
tuning the second filter from the start channel to a second channel adjacent to the start channel;
tuning the first optical filter from the first channel to a third channel adjacent to a target channel;
tuning the second optical filter from the second channel to a fourth channel adjacent to the target channel;
tuning the first optical filter from the third channel to the target channel; and
tuning the second optical filter from the fourth channel to the target channel.

9. The reconfigurable OADM of claim 1, wherein:
the first filter may drop a first set of channels; and
the second filter may drop a second set of channels.

10. The reconfigurable OADM of claim 9, wherein the first optical filter generates an intermediate dropped optical signal including a set of intermediate dropped channels in response to an input optical signal and a first channel select signal received from the controller, the intermediate dropped optical signal transmitted from the first optical filter's dropped port to the input port of the second optical filter.

11. The reconfigurable OADM of claim 10, wherein the second optical filter generates an intermediate expressed optical signal including a set of intermediate expressed channels in response to the intermediate dropped optical signal and a second channel select signal received from the controller, the intermediate expressed optical signal transmitted from the second optical filter's express port to the add port of the first optical filter.

12. The reconfigurable OADM of claim 11, wherein the first channel select signal selects a first set of dropped channels and the second channel select signal selects a second set of dropped channels having a non-empty intersection with the first set of dropped channels.

13. The reconfigurable OADM of claim 11, wherein the first channel select signal selects a first set of dropped channels and the second channel select signal selects a second set of dropped channels having an empty intersection with the first set of dropped channels.
